(19) United States
(12) Patent Application Publication
(10) Pub. No.: US 2026/0124931 A1
(43) Pub. Date: May 7, 2026

(54) IMPROVED ELECTRIC VEHICLE TRACTION INVERTER EFFICIENCY

(71) Applicant: GM GLOBAL TECHNOLOGY OPERATIONS LLC, Detroit, MI (US)

(72) Inventors: Renato Amorim Torres, Pontiac, MI (US); Chandra S. Namuduri, Troy, MI (US); Yilun Luo, Ann Arbor, MI (US)

(73) Assignee: GM GLOBAL TECHNOLOGY OPERATIONS LLC, Detroit, MI (US)

(21) Appl. No.: 18/934,669

(22) Filed: Nov. 1, 2024

(51) Int. Cl. B60L 50/51; B60L 50/60

(52) U.S. Cl. CPC B60L 50/51; B60L 50/60; B60L 2210/42; B60L 2240/421; B60L 2240/423; B60L 2240/525; B60L 2240/526

(57) ABSTRACT

A vehicle propulsion system including a system controller for determining a rotational speed and a rotational torque in response to a user input and a vehicle operating mode, a battery for supplying a DC current, an electric motor configured to generate the rotational torque at the rotational speed in response to an AC voltage, an inverter for transforming the DC current into the AC current using a first transistor and a second transistor, and an inverter controller for determining a dead time in response to the rotational torque and the rotational speed and for removing a first switching control signal from the first transistor, waiting a time duration equal to the dead time, and applying a second switching control signal to the second switching transistor and wherein the dead time is continuously updated in response to a change in the torque and a change in the rotational speed.

### INTRODUCTION

The present disclosure generally relates to electric vehicle motors and battery systems, and more particularly relates to a method and apparatus to utilize adjustable dead time in a traction inverter to minimize the conduction losses while simultaneously preventing any shoot-through in the inverter phase legs by utilizing power devices with minimum switching times and gate charges to enable shorter dead times.

Electric motors are used in electric vehicles (EV) to convert electrical energy from the battery into mechanical energy to turn the wheels. Typically, there are two main types of electric motors used in EVs: induction motors and permanent magnet synchronous motors (PMSMs). Modern EVs typically have two electric motors, one for each axle, but some EVs can have a single motor located under the hood or four motors, one for each wheel.

EV motors are typically driven by three phase alternating current (AC) currents. As EV batteries supply direct current (DC) voltage, the DC voltage has to be converted to three phase AC. This conversion is performed by an inverter. An inverter serves as a power electronic interface between the battery and the electric motor to convert the DC power stored in the battery into AC power that is compatible with the motor's requirements. By precisely regulating the voltage and frequency of the AC output, the inverter enables precise control of the motor's speed and torque. This control is essential for achieving optimal vehicle performance, efficiency, and responsiveness.

Inverters typically employ switching transistors which are switched on and off at regular intervals to go convert the DC voltage into three AC voltages, with each of the AC voltages supplied to a different winding of the AC motor. To prevent shorts circuits from occurring in the inverter when multiple transistors are simultaneously turned on, a deliberate interval is introduced between switching off one transistor before turning on another. This time interval is typically referred to as dead time. While it is essential for safety, dead time can also introduce inefficiencies due to increased conduction losses across the freewheeling diode during this period. It is desirable to efficiently provide employ inverter deadtimes as efficiently as possible to reduce any energy waste in order to provide systems and methods for vehicle propulsion and driver assistance systems. Furthermore, other desirable features and characteristics of the present disclosure will become apparent from the subsequent detailed description and the appended claims, taken in conjunction with the accompanying drawings and the foregoing technical field and background.

### SUMMARY

Disclosed herein are vehicle control methods and systems and related electrical systems for provisioning vehicle propulsion systems, methods for making and methods for operating such systems, and motor vehicles and other equipment such as aircraft, trucks, buses, forklifts, construction vehicles and other electric vehicles equipped with battery powered electric motors. By way of example, and not limitation, there are presented various embodiments of systems to optimize a traction inverter's efficiency by implementing adaptive dead time control, to minimize conduction losses while ensuring zero shoot-through events, and to employ power devices with rapid switching characteristics and low gate charges to enable shorter dead times.

In accordance with an exemplary embodiment of the present disclosure, an inverter controller for an electric motor including a system controller for determining a rotational torque and a rotational speed for an electric motor, the electric motor for generating the rotational torque at the rotational speed in response to an AC voltage, a battery for supplying a DC voltage, an inverter including a first transistor and a second transistor for transforming the DC voltage into the AC voltage, and an inverter controller for determining a dead time in response to the rotational torque and the rotational speed and for removing a first switching control signal from the first transistor, waiting a time duration equal to the dead time, and applying a second switching control signal to the second transistor and wherein the dead time is continuously updated in response to a change in the rotational torque and a change in the rotational speed.

In accordance with another exemplary embodiment of the present disclosure further including a temperature sensor for detecting a first temperature of the first transistor and a second temperature of the second transistor and wherein the dead time is determined in response to the first temperature and the second temperature.

In accordance with another exemplary embodiment of the present disclosure wherein the inverter controller is configured to adjust the dead time by adjusting a slew rate of the first switching control signal and the second switching control signal.

In accordance with another exemplary embodiment of the present disclosure wherein slew rate is increased in response to a decrease in a battery voltage.

In accordance with another exemplary embodiment of the present disclosure wherein the inverter controller is configured to adjust the dead time in response to at least one of a vehicle speed, a throttle position, a steering angle, and a battery voltage.

In accordance with another exemplary embodiment of the present disclosure wherein the inverter controller is configured to adjust the dead time in response to at least one of an inverter output current magnitude, a junction temperature and a power module temperature.

In accordance with another exemplary embodiment of the present disclosure wherein the inverter controller is configured to adjust the dead time as a function of a set of gate driver parameters of at least one of the first transistor and the second transistor.

In accordance with another exemplary embodiment of the present disclosure wherein the inverter controller is configured to reduce the dead time in response to at least one of a reduced inverter current and a reduced bus voltage and to increase the dead time in response to at least one of an increase in an inverter current and an increased bus voltage.

In accordance with another exemplary embodiment of the present disclosure wherein the inverter controller is configured to adjust the dead time in response to a switching frequency of the electric motor.

In accordance with another exemplary embodiment of the present disclosure, a method of controlling a switching inverter for an electric motor for vehicular applications including determining, by a system controller, for a rotational torque and a rotational speed for an electric motor, generating, by the electric motor, the rotational torque at the rotational speed in response to an AC voltage, supplying, by a battery, a DC voltage, transforming the DC voltage into the AC voltage by an inverter including a first transistor and a second transistor, and determining, by an inverter controller, a dead time in response to the rotational torque and the rotational speed and for removing a first switching control signal from the first transistor, waiting a time duration equal to the dead time, and applying a second switching control signal to the second transistor and wherein the dead time is continuously updated in response to a change in the rotational torque and a change in the rotational speed.

In accordance with another exemplary embodiment of the present disclosure wherein the first transistor and the second transistor are wide bandgap semiconductors.

In accordance with another exemplary embodiment of the present disclosure wherein the first transistor and the second transistor have a variable gate driver voltage level and wherein the dead time is determined in response to the variable gate driver voltage level.

In accordance with another exemplary embodiment of the present disclosure wherein the inverter controller is configured to continuously adjust the dead time in response to a change in at least one of the rotational torque, the rotational speed, a vehicle speed, a throttle position, a braking application level, a steering angle, a temperature of the first transistor, a temperature of the second transistor, a change in a magnitude of a battery voltage.

In accordance with another exemplary embodiment of the present disclosure wherein the inverter controller is further configured to update a dead time register within a PWM output section of a controller hardware prior to issuing a new current command in response to the new current command is higher than a threshold.

In accordance with another exemplary embodiment of the present disclosure wherein the inverter controller is further configured to update a dead time register within a PWM output section of a controller hardware prior to issuing a new current command in response to the new current command is lower than a threshold.

In accordance with another exemplary embodiment of the present disclosure where the inverter controller is further configured to update the dead time to be effective after a predetermined number of PWM cycles.

In accordance with another exemplary embodiment of the present disclosure wherein the inverter controller is communicatively coupled to at least one of a look-up table and a closed form equation for the dead time to be varied to minimize at least one of an inverter conduction loss, a current harmonic, a torque harmonic and a noise, vibration and harshness level.

In accordance with another exemplary embodiment of the present disclosure wherein the dead time is applied within a fundamental cycle of a waveform of the AC voltage in order reduce a conduction loss at under a low speed, high torque creep condition.

In accordance with another exemplary embodiment of the present disclosure, a vehicle propulsion system including a system controller for receiving a user input via a user interface and for determining a rotational speed and a rotational torque in response to the user input and a vehicle operating mode, a battery for supplying a DC current, a three phase electric motor configured to generate the rotational torque at the rotational speed in response to an AC voltage, an inverter for transforming the DC current into the AC voltage using a first transistor and a second transistor, and an inverter controller for determining a dead time in response to the rotational torque and the rotational speed and for removing a first switching control signal from the first transistor, waiting a time duration equal to the dead time, and applying a second switching control signal to the second transistor and wherein the dead time is continuously updated in response to a change in the rotational torque and a change in the rotational speed.

In accordance with another exemplary embodiment of the present disclosure wherein the inverter controller is configured to continuously adjust the dead time in response to a change in at least one of the rotational torque, the rotational speed, a vehicle speed, a throttle position, a braking application level, a steering angle, a temperature of the first transistor, a temperature of the second transistor, a change in a magnitude of a battery voltage.

### BRIEF DESCRIPTION OF THE DRAWINGS

The exemplary embodiments will hereinafter be described in conjunction with the following drawing figures, wherein like numerals denote like elements, and wherein:

FIG. 1 is illustrative of a vehicle employing one or more electric vehicle motors and battery systems in accordance with various embodiments;

FIG. 2 is illustrative of an EV propulsion system is shown in accordance with various embodiments;

FIG. 3 shows a schematic representation of an EV propulsion system in accordance with various embodiments;

FIG. 4 shows a block diagram representation of an EV propulsion inverter control system in accordance with various embodiments; and

FIG. 5 shows a flowchart illustrating an exemplary method for controlling an EV propulsion inverter in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application-specific integrated circuit (ASIC), a field-programmable gate array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, lookup tables, or the like, which may carry out a variety of functions under the control of one or more microprocessors or other control devices. In addition, those skilled in the art will appreciate that embodiments of the present disclosure may be practiced in conjunction with any number of systems and that the systems described herein are merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

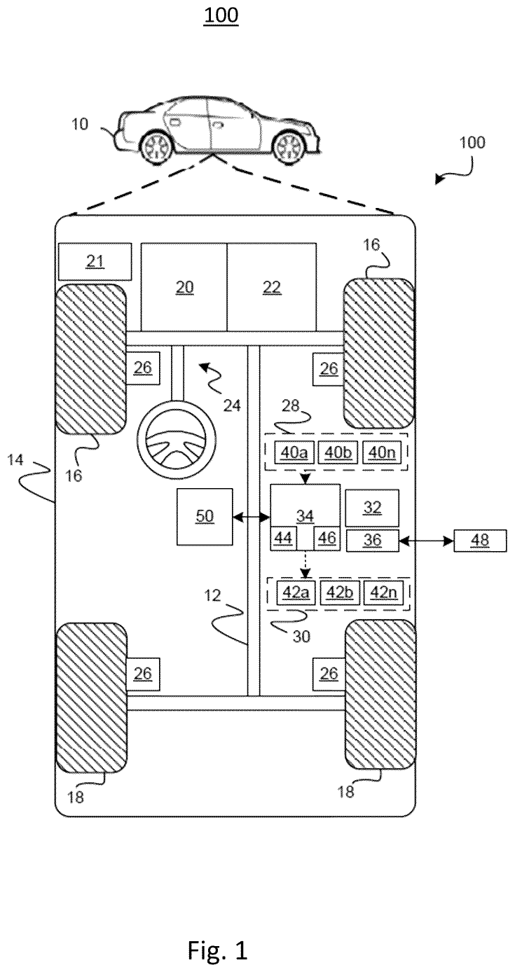

With reference to FIG. 1, a vehicle 10 is shown employing one or more electric vehicle motors and battery systems, and more particularly employs a dynamically adjustable traction inverter to utilize adjustable dead time to minimize the conduction losses while simultaneously preventing any shoot-through in the inverter phase legs by utilizing power devices with minimum switching times and gate charge to enable shorter dead times.

As shown in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near a respective corner of the body 14.

The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In various embodiments, the vehicle 10 can be an autonomous vehicle that is automatically controlled to carry passengers and/or cargo from one location to another. In an exemplary embodiment, the vehicle 10 can have an automation system of Level Two or higher. A Level Two automation system indicates “partial automation.” However, in other embodiments, the autonomous vehicle may be a so-called Level Three, Level Four or Level Five automation system. A Level Three automation system indicates conditional automation. A Level Four system indicates “high automation,” referring to the driving mode-specific performance by an automated driving system of all aspects of the dynamic driving task, even when a human driver does not respond appropriately to a request to intervene. A Level Five system indicates “full automation”, referring to the full-time performance by an automated driving system of all aspects of the dynamic driving task under all roadway and environmental conditions that can be managed by a human driver.

However, it is to be understood that the vehicle 10 may also be a conventional vehicle without any autonomous driving functions. The vehicle 10 may implement the functions and methods for generating a virtual view having harmonized color in accordance with the present disclosure.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, a fuel cell propulsion system, and/or a combination thereof. The transmission system 22 is configured to transmit power from the propulsion system 20 to the vehicle wheels 16 an 18 according to selectable speed ratios. According to various embodiments, the transmission system 22 may include a step-ratio automatic transmission, a continuously-variable transmission, a manual transmission, or any other appropriate transmission.

The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the of the vehicle wheels 16 and 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems (GPS), optical cameras, thermal cameras, ultrasonic sensors, and/or other sensors. The sensing devices 40a-40n are further configures to sense observable conditions of the vehicle 10. The sensing devices 40a-40n can include, but are not limited to, speed sensors, position sensors, inertial measurement sensors, temperature sensors, pressure sensors, etc.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

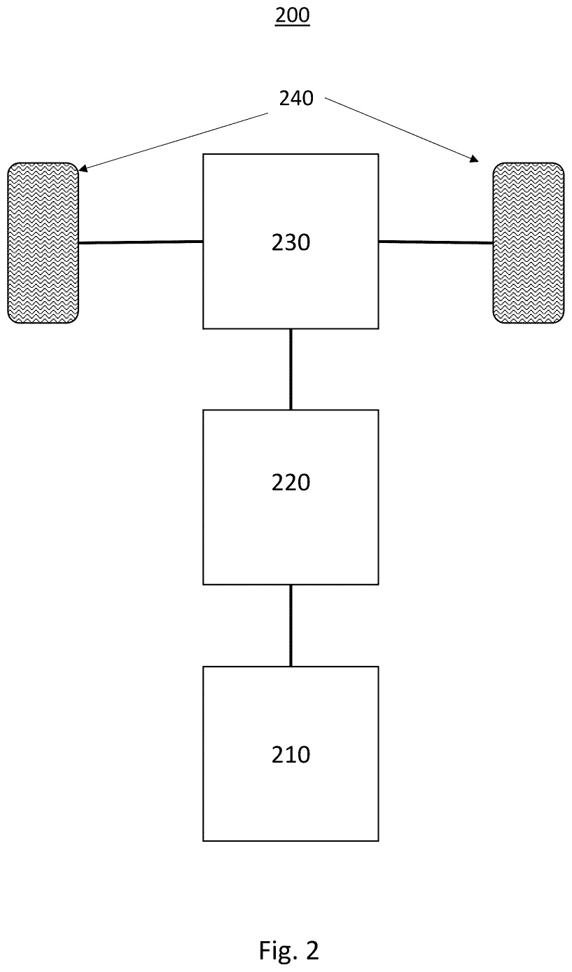

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling functions of the vehicle 10. In various embodiments, the data storage device 32 stores defined maps of the navigable environment. The defined maps may include a variety of data other than road data associated therewith, including elevation, climate, lighting, etc. In various embodiments, the defined maps may be predefined by and obtained from a remote system (described in further detail with regard to FIG. 2). For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling and executing functions of the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In various embodiments, one or more instructions of the controller 34 are embodied in the surround view display system 100 and, when executed by the processor 44, process image data from at least one optical camera of the sensor system 28 to extract features from the images in order to determine the ground plane. The instructions, when executed by the processor 44, use the ground plane to determine camera alignment information. The camera alignment information is then used to assemble the image data to form a surround view from a defined perspective. In various embodiments, the sensing devices 40a to 40n include N (one or more) cameras that sense an external environment of the vehicle 10 and generate the image data (e.g., optical cameras that are configured to capture color pictures of the environment). The cameras are disposed so that they each cover a certain field of view of the vehicle's surroundings. The image data from each camera is assembled into a surround view based on, for example, the pose and the location of the camera relative to the vehicle and relative to the ground.

It will be appreciated that the controller 34 may otherwise differ from the embodiments depicted in FIG. 1. For example, the controller 34 may be coupled to or may otherwise utilize one or more remote computer systems and/or other control systems, for example as part of one or more of the above-identified vehicle devices and systems. It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 44) to perform and execute the program. Such a program product may take a variety of forms, and the present disclosure applies equally regardless of the particular type of computer-readable signal bearing media used to carry out the distribution. Examples of signal bearing media include recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 34 may also otherwise differ from the embodiment depicted in FIG. 1, for example in that the computer system of the controller 34 may be coupled to or may otherwise utilize one or more remote computer systems and/or other control systems.

Turning now to FIG. 2, a schematic representation of an EV propulsion system 200 is shown. The schematic is representative of the battery 210, the inverter 220 and the drive motor 230. The battery 210 is configured to provide DC power to the inverter circuitry 220. The inverter 220 is configured to receive the DC power from the battery 210 and to transform the DC power into a three-phase AC current required by the electric motor 230 to rotate the plurality of wheels 240.

The energy source for an EV is the battery 210, a high-fidelity energy storage system designed for robust power delivery to the electric motor 230. Unlike traditional internal combustion engines fueled by gasoline, EVs rely on these rechargeable batteries 210. Each battery 110 can be configured from numerous lithium-ion cells strategically connected in series and parallel configurations to achieve the desired output voltage and capacity. The battery 210 functions through a well-defined electrochemical process occurring between the anode and cathode. The positive anode, typically comprised of lithium cobalt oxide (LiCoO2), and the negative graphite cathode harbor the key for generating electricity. During discharge, lithium ions shuttle between the electrodes, flowing from the anode to the cathode. This movement of ions is accompanied by a corresponding flow of electrons through an external circuit, ultimately powering the electric motor 230. To reverse this process and replenish the battery's energy reserves, the EV is plugged into a charging station. Electrons from the charger flow in the opposite direction, causing lithium ions to migrate back to the anode. This meticulously controlled flow of ions and electrons defines the charging and discharging cycles that the battery 210 performs throughout its operational lifespan.

Ensuring the efficient and safe operation of the battery 210 is the responsibility of the battery management system (BMS). This sophisticated computer system regulates factors like cell voltage, current, and temperature. In monitoring these parameters, the BMS optimizes battery performance, extends its useful life, and prioritizes safety. It achieves this by constantly balancing the voltages across individual cells within the pack, preventing any from experiencing overcharging or over-discharging conditions that could lead to damage. Furthermore, the BMS serves as a vital communication hub, relaying real-time data on battery health and remaining range to the vehicle's onboard diagnostics system. This information is crucial for the driver to make informed decisions regarding charging needs and optimize their travel experience.

Within the EV propulsion system 200, the DC-AC inverter 220 acts as a critical interface between the high-voltage battery 210 and the electric motor 230. The inverter 220 is configured to efficiently convert the DC output from the battery 210 into a precisely controlled, three-phase AC current to be supplied to the electric motor 230. Employing power devices such as insulated-gate bipolar transistors (IGBTs) or metal-oxide-semiconductor field-effect transistor (MOSFET) in a pulse-width modulation (PWM) scheme, the inverter 120 synthesizes the desired AC waveforms. This three-phase AC output is characterized by three sinusoidal waveforms, each offset by 120 degrees relative to the others. This strategic manipulation by the inverter 220 is crucial as it engenders a rotating magnetic field within the electric motor 230. The configuration of the switching sequence dictates the rotational speed and torque of the motor 230 to enable smooth and efficient vehicle operation.

In some exemplary embodiments, the inverter 220 leverages high-performance power devices (such as IGBTs or MOSFETS) as the core building blocks, while gate driver circuits and advanced control algorithms ensure their precise and efficient operation. A sensor suite can be employed to monitor voltage and current changes within the system, feeding real-time data to the BMS. This continuous feedback loop facilitates ongoing adjustments and optimizations, guaranteeing the inverter operates at peak efficiency across diverse driving conditions. In addition, thermal management plays a crucial role in maximizing inverter efficiency. The design can use low-resistance materials, high-switching speeds, and continuously adjustable dead times to minimize internal energy losses. During regenerative braking, the inverter 220 can be employed to recapture kinetic energy from the vehicle's deceleration and transforms this energy back into DC power, effectively replenishing the battery 210. This regenerative energy conversion enhances overall driving range and illustrates the bidirectional function of the inverter 220 in the EV propulsion system 200.

Leveraging the principles of electromagnetism, the electric motor 230 can be an induction motor or a permanent magnet synchronous motor (PMSM) having high efficiency and power density. Unlike internal combustion engines, the PMSM transforms electrical energy stored in the DC battery pack via the inverter 120 into mechanical rotation to propel the vehicle. The electric motor 230 is comprised of two key components: the stator and the rotor. The stator is a fixed, cylindrical shell that houses strategically placed permanent magnets. Encapsulating the stator is the rotor, a rotating shaft constructed from laminated steel segments. Embedded within these segments are windings which are coils of precisely wound conductive material. The interplay between the three-phase AC current supplied by the inverter 220 and the permanent magnets in the stator induces a current within the windings of the rotor. This induced current produces a reciprocal magnetic field around the rotor. The resulting interaction between these two magnetic fields exerts a torque on the rotor, causing it to spin continuously in the direction of the rotating magnetic field generated by the stator. Controlling the frequency and voltage of the three AC phases delivered by the inverter 220, regulates the speed and torque of the electric motor 230. This granular control ultimately dictates the vehicle's acceleration and overall performance.

The rotational force generated by the electric motor 230 is typically directly proportional to the current and magnetic field strength. However, to achieve optimal vehicle performance, this output speed typically needs further tailoring using a torque transfer system. In some exemplary embodiments, a reduction gear set acts as a crucial intermediary, functioning as a speed multiplier. This gearbox translates the high-speed, low-torque output of the motor into a lower-speed, high-torque output ideally suited for driving the wheels. This vital gear reduction enables the motor to operate within its most efficient range while simultaneously providing the substantial torque required to overcome vehicle inertia, rotate each of the plurality of wheels 240 and propel the vehicle forward.

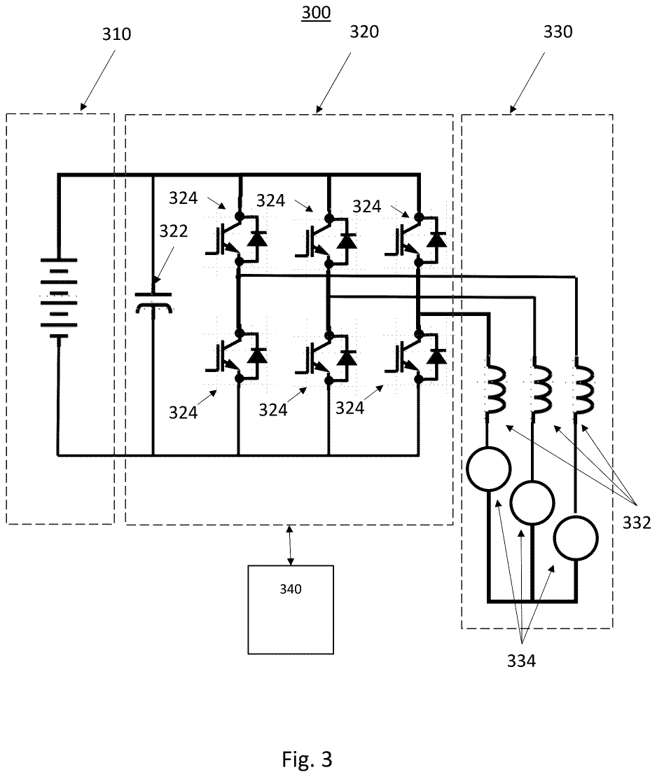

Turning now to FIG. 3, a schematic representation of an EV propulsion system 300 is shown. The schematic is representative of the battery 210, the inverter 220 and the drive motor 330. The battery 310 is configured to provide DC power to the inverter circuitry 320. The inverter 320 is configured to receive the DC power from the battery 310 and to transform the DC power into a three-phase AC current required by the electric motor 330. The inverter 320 rapidly switches the plurality of power switching devices 324, such as transistors, in a predetermined sequence, generating a pulsating DC output. In some exemplary embodiments, filters, such as a decoupling capacitor 322 placed between the power and ground pins of the inverter 320, to filter out noise and maintain stable power supply voltage during switching, or one or more load capacitors or inductors to remove unwanted harmonics, resulting in a clean, three-phase AC waveform at the inverter 320. Each phase carries a distinct AC current, meticulously orchestrated to create a rotating magnetic field within the motor. Each of the windings 332 in the stators of the drive motor 330 are connected to one of these three phases of currents. As the current flows through the windings 332, it creates a magnetic field. The interaction of the three phase-shifted currents produces a rotating magnetic field.

The inverter 320 rapidly switches the plurality of power switching devices 324, such as transistors, in a predetermined sequence, generating a pulsating DC output. The inverter controller 340 is configured to generate control signals to switch the plurality of power switching devices 324 in the desired order and for the desired duration, including the required dead time to avoid possible short circuits. In some exemplary embodiments, filters, such as a decoupling capacitor 322 placed between the power and ground pins of the inverter 320, to filter out noise and maintain stable power supply voltage during switching, or one or more load capacitors or inductors to remove unwanted harmonics, resulting in a clean, three-phase AC waveform at the inverter 320. Each phase carries a distinct AC current, meticulously orchestrated to create a rotating magnetic field within the motor. Each of the windings 332 in the stators of the drive motor 330 are connected to one of these three phases currents. As the current flows through the windings 332, it creates a magnetic field. The interaction of the three phase-shifted currents produces a rotating magnetic field.

In the drive motor 330, the rotating magnetic field from the stators interact with the windings or the magnets in the rotor of the drive motor 330. This interaction induces a current in the rotor windings 332, which in turn creates a force according to Lenz's Law. This force causes the rotor to try and align itself with the rotating magnetic field, resulting in continuous rotation of the motor shaft. This rotating field is the driving force behind the motor shaft's rotation, ultimately propelling the vehicle forward. The inverter's control system allows for precise manipulation of the AC output's frequency and voltage. This fine-tuned control enables the system to precisely regulate the motor's speed and torque, ensuring smooth, efficient, and optimized operation of the EV.

Dead time is a critical parameter in switching inverters that refers to a brief interval during which both the high-side and low-side power switching devices 324 of the same inverter leg are intentionally turned off. This deliberate pause is a safety measure to prevent simultaneous conduction, which can lead to a short circuit and damage the inverter components. When both switches are conducting, they create a direct path between the positive and negative DC supply terminals, resulting in excessive current flow. While dead-time is necessary to prevent short circuits, it also introduces a period of free-wheeling diode, or body diode, current conduction (3^{rd} quadrant conduction). During this time, the output voltage of the inverter 320 is either zero or the dc-link voltage depending on the phase current direction. The phase current direction defines whether high-side or low-side free-wheeling diode conducts current. The free-wheeling diode current conduction generates higher losses than the conduction losses through the channels of the power switching devices 324 therefore the inverter faces reduced inverter efficiency during dead time. The dead-time-related conduction losses can be significant, especially at higher switching frequencies as the time during which the free wheeling diode conducts current increases. As a result, the overall power dissipation within the inverter 320 increases, leading to potential thermal management challenges and reduced efficiency. Even though WBG devices such as lateral GaN HEMTs do not incorporate an intrinsic body diode, they can still behave as diodes, albeit lossy ones that allow the device to conduct reverse current even when the device is gated “OFF”. Therefore, the reduction of deadtime can also improve efficiency in GaN based inverters.

In some exemplary embodiments, the slew rate can be a function of the dead time. Slew rate is the rate of change of a signal's voltage or current. An increase in slew rate can result in a reduction of electromagnetic radiation from the inverter 320. However, an increase in slew rate results allows for a lower dead time, thereby potentially improving the efficiency of the inverter 320. For example, electric vehicle traction inverters can employ silicon carbide (SiC) and utilize fixed dead-time, such as ˜2.5 μs in their gate drivers. This fixed dead-time can result in substantial conduction losses during 3rd quadrant operation, where the Gate-Source junction is reverse biased, introducing a large voltage drop associated with the 3^{rd} quadrant conduction, leading to increased conduction losses. As the switching frequency rises, the duration of the dead-time as a percentage of the switching period of these conduction losses increases, exacerbating the problem. During each switching cycle there are two intervals of dead time. It is desirable to utilize adjustable dead time in the inverter 320 to minimize the conduction losses while simultaneously preventing any shoot-through in the inverter phase legs and to utilize switching devices with minimum switching times and gate charge to enable shorter dead times.

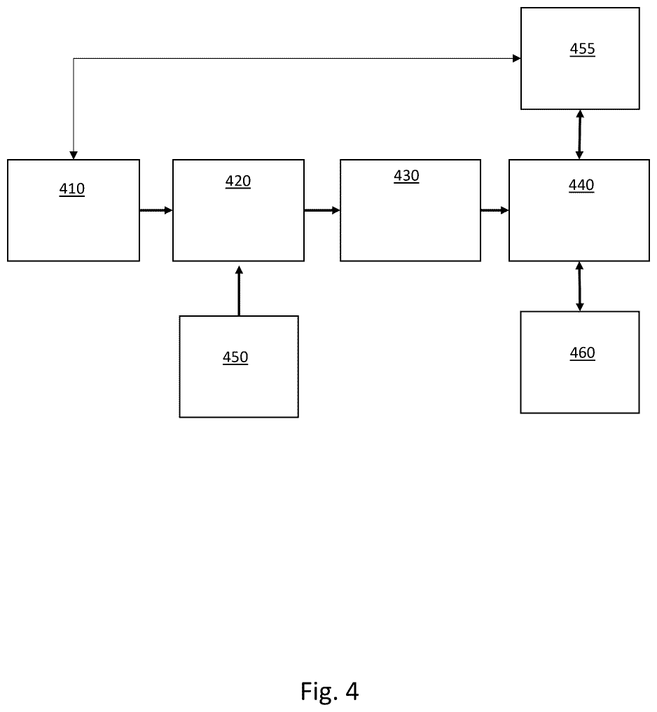

Turning now to FIG. 4, a block diagram representation of an EV propulsion inverter control system 400 is shown. The inverter control system 400 can include a system controller 410, inverter controller 420, gate driver 430, inverter power stage 440, electric motor 460 and temperature sensor 450.

The system controller 410 in an EV is responsible for overall vehicle management, while the inverter controller 420 specifically manages the power conversion between DC direct current from the battery and AC for the electric motor 460. In some exemplary embodiments, the system controller 410 can send data to the inverter controller 420 to ensure optimal performance, efficiency, and safety. Data transmitted from the system controller to the inverter controller 420 can include motor speed and torque demands, vehicle mode, battery state of charge (SOC), battery temperature, vehicle speed and safety information.

The system controller 410 can determine the desired motor speed and torque based on driver input, such as accelerator pedal position and vehicle dynamics. It sends this data to the inverter controller 420, which adjusts the inverter's output accordingly. The system controller 410 can further communicate the current vehicle speed and current vehicle mode, such as drive, reverse, and regenerative braking, to the inverter controller 420 to enable the inverter controller 420 to adjust operation to suit the specific driving condition and for various control strategies, including regenerative braking and traction control. Likewise, the system controller 410 can provide the inverter controller 420 with the current battery SOC and the battery temperature received from the battery controller. In addition, the system controller 420 may send safety-related information, such as fault codes or emergency shutdown commands, to the inverter controller 420. This helps prevent catastrophic failures and ensure the vehicle's safety.

The inverter controller 420 is configured to convert DC power from the battery into three phase AC power to supply to the electric motor 460 in response to the data received from the system controller 410. The inverter controller 420 controls the gate drivers 430 which are used to switch the transistors in the inverter power stage 440. The inverter controller 420 can control the frequency and voltage of the AC output to allow for precise control of the motor's speed and torque. During regenerative braking, the inverter controller 420 can control the inverter switching for converting the kinetic energy of the vehicle into electrical energy and storing it back in the battery 460. The inverter controller 420 can monitor its own operation and can detect faults or abnormal conditions in order to implement protective measures to prevent damage to itself or other components of the system.

In order to optimize system efficiency, the exemplary inverter controller 420 is configured with real-time controllable dead time adjustment to determine and adjust the dead time to prevent shoot through between the upper and lower power switch in each of the phase legs in the EV drive system. At power up the dead time can be set to a predetermined value to assure no shoot through. An inverter controller 420 can establish a default dead time at power-up by evaluating multiple operating parameters. The inverter controller 420 can initially calculate the worst-case current and voltage scenarios the inverter may encounter, incorporating factors such as maximum load current and minimum input voltage. The real time dead time can be applied within a fundamental cycle of the sinusoidal current to achieve further loss reduction at low speed, high torque creep conditions. Subsequently, the inverter controller 420 can then account for the temperature range within which the inverter will operate, as elevated temperatures can increase switching losses and diminish device performance. The inverter controller 420 can then assess the driver delays and gate drive parameters, which influence the MOSFETs'on and off times. Finally, the inverter controller 420 calculates the worst-case switching times based on the device characteristics and operating conditions. By comprehensively considering these factors, the inverter controller 420 can determine a suitable default dead time that ensures safe and efficient operation under the most demanding circumstances.

To prevent shoot-through and ensure safe operation, the inverter controller 420 in EVs can employ a predetermined dead time at power-up. This dead time establishes a minimum interval between the turn-off of one switch and the turn-on of the other, preventing the direct connection of the DC supply terminals. To enhance efficiency and reduce losses, particularly in low-speed, high-torque creep conditions, real-time dead time modulation can be implemented. By dynamically adjusting the dead time within a fundamental cycle of the sinusoidal current, the inverter's switching behavior can be optimized, leading to reduced power dissipation and improved overall efficiency.

The inverter controller 420 can employ various algorithms to determine the minimum required dead time. These algorithms can take into account various operating conditions, including discrete levels of current, voltage, temperature, and gate driver parameters. By analyzing these factors, the controller can accurately calculate the necessary dead time to prevent shoot-through, a condition where both switches of a half-bridge are simultaneously turned on. In order to minimize conduction losses, the inverter controller 340 can then dynamically adjust the dead time at any operating point. This can involve utilizing predetermined data to calculate the optimal dead time based on factors like switching frequency, load current, and temperature received from the temperature sensor 450. By continuously monitoring these parameters, the controller can rapidly adjust the dead time to ensure that the switches are conducting for the minimum necessary duration while still preventing short circuits. This dynamic adjustment not only reduces power dissipation but also improves the overall efficiency and reliability of the inverter system. In addition, Wide-bandgap (WBG) switches, such as Gallium Nitride (GaN) and Silicon Carbide (SiC), offer significant advantages for inverter design. Their low gate charge enables faster switching times and reduced delays, leading to a reduction in dead time. This is particularly beneficial in high-frequency applications where minimizing dead time is crucial for improving efficiency and reducing power losses. By incorporating WBG switches, inverters can achieve higher switching frequencies and lower overall system losses. The disclosed system, while exemplary utilizing a temperature sensor (450) to derive optimal dead time based on factors such as switching frequency, load current, and sensed temperature, is not constrained to this specific configuration. The integration of various automotive sensors, including but not limited to current sensors and speed/position sensors, is contemplated. Such additional sensor inputs can provide valuable contextual data that may significantly impact the selection of optimal dead time, thereby enhancing the system's adaptability and overall performance.

In some exemplary embodiments, the inverter controller 420 can determine the inverter power state 440 output current command amplitude and frequency based on vehicle conditions and driver inputs. The inverter controller 420 can adjust the dead time as a function of the EV operating conditions, such as vehicle speed, driver pedal position, battery voltage, inverter output current magnitude, measured or estimated junction or power module temperature. The inverter controller 420 can adjust gate driver parameters such as slew rate control as a function of the EV operating conditions such as vehicle speed, driver pedal position, battery voltage, inverter output current magnitude, measured or estimated junction or power module temperature. The inverter controller 420 can adjust the dead time as a function of the gate driver parameters. The switching event slew rate can be increased at lower battery voltages while complying with EMC/EMI. The faster slew rate allows reducing dead-time. The inverter controller 420 can reduce the dead time at lower current commands and/or bus voltages and increase the dead time at higher current commands and/or bus voltages to reduce conduction losses over EV drive cycle. In some exemplary embodiments, the dead time can be adjusted as a function of switching frequency and/or the fundamental frequency of the drive motor.

In some exemplary embodiments, the inverter controller 420 can update a dead time register within the pulse width modulated (PWM) output section of the controller hardware prior to issuing a new current command in the case of a new current command being higher than a threshold. The inverter controller 420 can update the dead time register within the PWM output section of the controller hardware after issuing a new current command in case of new current command is lower than a threshold. The inverter controller 420 can allow for the new dead time to be effective in the next PWM cycle or after a predetermined number of PWM cycles The inverter controller 420 can include a look-up table or a closed form equation for the dead time to be varied as a function of multiple variables to achieve various objectives, such as, minimizing inverter conduction losses and minimizing current/torque harmonics and noise, harshness and vibration (NHV).

A gate driver 430 in an electric vehicle power inverter system is configured for controlling the switching of power semiconductor devices, such as insulated-gate bipolar transistors (IGBTs) or MOSFETs in the inverter power stage 440. By providing precise, high-current, and high-speed switching signals in response to control signals received from the inverter controller 420, the gate drivers 430 ensure efficient power conversion and accurate control of the inverter's output voltage and frequency. This, in turn, enables precise regulation of the electric motor's speed and torque, contributing to the overall performance and efficiency of the electric vehicle's propulsion system. In some exemplary embodiments, the gate driver 430 can supply variable gate driver voltage levels, including negative voltages, variable gate driver current levels, variable gate driver impedance, and dead time selection dependent on defined gate driver voltage level.

The inverter power stage 440 can be configured for the actual conversion of DC from the battery 455 into AC that drives the electric motor 460. This conversion is achieved through the use of electronic switches, typically power MOSFETs or IGBTs. These switches are arranged in a configuration known as a bridge, which allows the DC voltage to be rapidly switched between positive and negative terminals, creating a pulsating DC voltage. This pulsating DC voltage is then filtered to produce the desired AC output. The inverter power stage 440 receives switching voltages from the gate drivers 430 which controls the switching of the electronic switches. The inverter power stage 440 can further include passive components like capacitors and inductors, which filter the output waveform and provide impedance matching. In some exemplary embodiments, the switching devices are WBG semiconductors with low gate charge that enable shorter possible dead times.

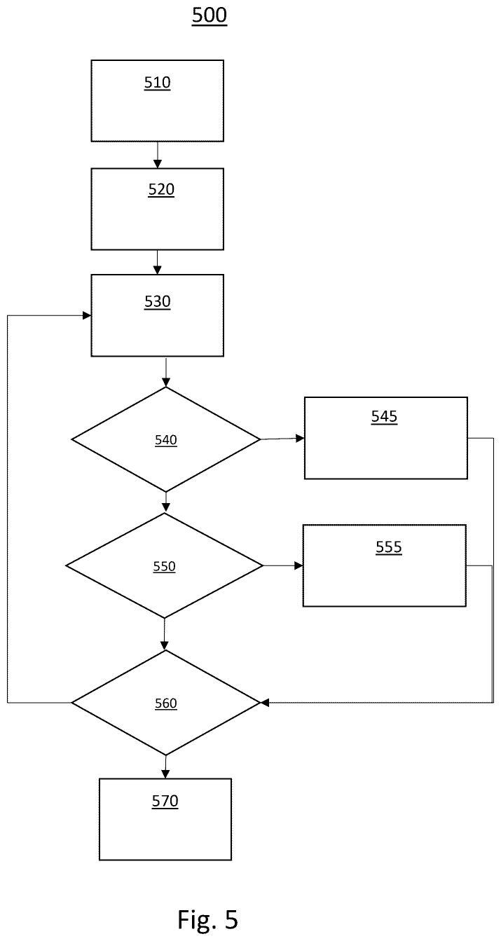

Turning now to FIG. 5, a flowchart illustrating an exemplary method 500 for controlling an EV propulsion inverter is shown in accordance with an embodiment. Th method 500 is configured to dynamically adjust an EV drive motor switching inverter to minimize the conduction losses while simultaneously preventing any shoot-through in the inverter phase legs by utilizing power devices with minimum switching times and gate charges to enable shorter dead times.

The method 500 is first operative to set 510 a default dead time. In some exemplary embodiments, the default dead time can be established during system design and stored in a memory or a lookup table. To determine the default dead time, the method 500 can load 520 dead time tables from the memory or the like. In some exemplary embodiments, the method can establish a default dead time at power-up by comprehensively evaluating various operating parameters. By considering factors such as maximum load current, minimum input voltage, temperature range, driver delays, gate drive parameters, and device characteristics, the method 500 can calculate the worst-case current and voltage scenarios. This analysis enables the determination of a suitable default dead time that ensures safe and efficient operation under the most demanding conditions. In some exemplary embodiments, the lookup tables can define regions of torque and speed with predetermined dead times. These lookup tables may further include current temperature and gate driver parameters.

In response to setting the default dead time, the method 500 is next operative to read 530 the current commands Is* from the system controller or the like. If the current commands Is* is greater than a first threshold level (I1) 540, the method 500 sets to dead time to a first dead time (td1) 545. The method 500 then determines if 560 the td setting algorithm is to be exited. If the current commands Is* is less than a first threshold level (I1) 560, the method sets the dead time to a second dead time (td2) 555. The method 500 the determines if 560 the td setting algorithm is to be exited.

If the dead time setting algorithm is to be exited 560, the algorithm is exited 570. If the td setting algorithm is to be continued, representative of a situation where the dead time is constantly varied, the method returns to read 530 the current command Is.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An inverter controller for an electric motor comprising:
a system controller for determining a rotational torque and a rotational speed for an electric motor;
the electric motor for generating the rotational torque at the rotational speed in response to an AC voltage;
a battery for supplying a DC voltage;
an inverter including a first transistor and a second transistor for transforming the DC voltage into the AC voltage; and
an inverter controller for determining a dead time in response to the rotational torque and the rotational speed and for removing a first switching control signal from the first transistor, waiting a time duration equal to the dead time, and applying a second switching control signal to the second transistor and wherein the dead time is continuously updated in response to a change in the rotational torque and a change in the rotational speed.

2. The inverter controller for the electric motor of claim 1, further including a temperature sensor for detecting a first temperature of the first transistor and a second temperature of the second transistor and wherein the dead time is determined in response to the first temperature and the second temperature.

3. The inverter controller for the electric motor of claim 1, wherein the inverter controller is configured to adjust the dead time by adjusting a slew rate of the first switching control signal and the second switching control signal.

4. The inverter controller for the electric motor of claim 3, wherein slew rate is increased in response to a decrease in a battery voltage.

5. The inverter controller for the electric motor of claim 1, wherein the inverter controller is configured to adjust the dead time in response to at least one of a vehicle speed, a throttle position, a steering angle, and a battery voltage.

6. The inverter controller for the electric motor of claim 1, wherein the inverter controller is configured to adjust the dead time in response to at least one of an inverter output current magnitude, a junction temperature and a power module temperature.

7. The inverter controller for the electric motor of claim 1, wherein the inverter controller is configured to adjust the dead time as a function of a set of gate driver parameters of at least one of the first transistor and the second transistor.

8. The inverter controller for the electric motor of claim 1, wherein the inverter controller is configured to reduce the dead time in response to at least one of a reduced inverter current and a reduced bus voltage and to increase the dead time in response to at least one of an increase in an inverter current and an increased bus voltage.

9. The inverter controller for the electric motor of claim 1, wherein the inverter controller is configured to adjust the dead time in response to a switching frequency of inverter or the a fundamental frequency of the electric motor.

10. A method of controlling a switching inverter for an electric motor for vehicular applications comprising:
determining, by a system controller, for a rotational torque and a rotational speed for an electric motor;
generating, by the electric motor, the rotational torque at the rotational speed in response to an AC voltage;
supplying, by a battery, a DC voltage;
transforming the DC voltage into the AC voltage by an inverter including a first transistor and a second transistor; and
determining, by an inverter controller, a dead time in response to the rotational torque and the rotational speed and for removing a first switching control signal from the first transistor, waiting a time duration equal to the dead time, and applying a second switching control signal to the second transistor and wherein the dead time is continuously updated in response to a change in the rotational torque and a change in the rotational speed.

11. The method of controlling the switching inverter for the electric motor for vehicular applications of claim 10, wherein the first transistor and the second transistor are wide bandgap semiconductors.

12. The method of controlling the switching inverter for the electric motor for vehicular applications of claim 10, wherein the first transistor and the second transistor have a variable gate driver voltage level and wherein the dead time is determined in response to the variable gate driver voltage level.

13. The method of controlling the switching inverter for the electric motor for vehicular applications of claim 10, wherein the inverter controller is configured to continuously adjust the dead time in response to a change in at least one of the rotational torque, the rotational speed, a vehicle speed, a throttle position, a braking application level, a steering angle, a temperature of the first transistor, a temperature of the second transistor, a change in a magnitude of a battery voltage, and a change in a magnitude of a phase current.

14. The method of controlling the switching inverter for the electric motor for vehicular applications of claim 10, wherein the inverter controller is further configured to update a dead time register within a PWM output section of a controller hardware prior to issuing a new current command in response to the new current command is higher than a threshold.

15. The method of controlling the switching inverter for the electric motor for vehicular applications of claim 10, wherein the inverter controller is further configured to update a dead time register within a PWM output section of a controller hardware prior to issuing a new current command in response to the new current command is lower than a threshold.

16. The method of controlling the switching inverter for the electric motor for vehicular applications of claim 10, where the inverter controller is further configured to update the dead time to be effective after a predetermined number of PWM cycles.

17. The method of controlling the switching inverter for the electric motor for vehicular applications of claim 10, wherein the inverter controller is communicatively coupled to at least one of a look-up table and a closed form equation for the dead time to be varied to minimize at least one of an inverter conduction loss, a current harmonic, a torque harmonic and a noise, vibration and harshness level.

18. The method of controlling the switching inverter for the electric motor for vehicular applications of claim 10, wherein the dead time is applied within a fundamental cycle of a waveform of the AC voltage in order reduce a conduction loss.

19. A vehicle propulsion system comprising:
a system controller for receiving a user input via a user interface and for determining a rotational speed and a rotational torque in response to the user input and a vehicle operating mode;
a battery for supplying a DC current;
a three phase electric motor configured to generate the rotational torque at the rotational speed in response to an AC voltage;
an inverter for transforming the DC current into the AC voltage using a first transistor and a second transistor; and
an inverter controller for determining a dead time in response to the rotational torque and the rotational speed and for removing a first switching control signal from the first transistor, waiting a time duration equal to the dead time, and applying a second switching control signal to the second transistor and wherein the dead time is continuously updated in response to a change in the rotational torque and a change in the rotational speed.

20. The vehicle propulsion system of claim 19, wherein the inverter controller is configured to continuously adjust the dead time in response to a change in at least one of the rotational torque, the rotational speed, a vehicle speed, a throttle position, a braking application level, a steering angle, a temperature of the first transistor, a temperature of the second transistor, a change in a magnitude of a battery voltage.
